(19) United States
(12) Patent Application Publication
(10) Pub. No.: US 2005/0282621 A1
(43) Pub. Date: Dec. 22, 2005

(54) CPU upgrading adapter for a Microsoft XboxTM game machine

(76) Inventor: Ta-Shin Hu, Sanchung City (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/645,383

(22) Filed: Aug. 21, 2003

(51) Int. Cl. A63F 9/24; G06F 19/00

(52) U.S. Cl. 463/23

(57) ABSTRACT

A CPU upgrading adapter for an XBOX game machine is composed of a circuit board on which a socket frame and a switched are electrically connected. When the original CPU is removed from a motherboard of the XBOX game machine, the CPU upgrading adapter is then mounted on the motherboard to receive a new high speed upgrading CPU. Such an upgrading CPU is chosen from an Intel© Pentium-III-S™ CPU, a Pentium-III™ CPU or a Celeron™ CPU.

### BACKGROUND OF THE INVENTION

1. Field of the Invention

The present invention relates to a CPU upgrading adapter with multiple operating frequency selections, and more particularly to a CPU upgrading adapter that is adapted for a Microsoft© Xbox™ game machine.

2. Description of Related Art

Microsoft™ has developed a game machine called XBOX™ that has a console for connecting to a monitor or the like by means of a special cable. In the XBOX™ game machine, a Mobile Pentium-III™ 733 MHz CPU (Coppermine Core, Micro-BGA packet, 128 KB L2-Cache and 495 pins) designed by Intel© is applied as the data processing core.

The performance of the XBOX™ game machine basically depends on the operating frequency of the CPU. However, in the situation where the game machine executes the 3D game software, the 733 MHz CPU is unable to quickly process such a great quantity of data.

To mitigate and/or obviate the aforementioned problem, the present invention provides a novel CPU upgrading adapter with multiple frequency selections to allow a high operating frequency CPU to be applied to an existing XBOX™ game machine.

### SUMMARY OF THE INVENTION

One objective of the present invention is to provide a CPU upgrading adapter with multiple frequency selection adapted for an upgrading CPU.

To accomplish the objective, the CPU upgrading adapter in accordance with the present invention comprises:
a socket frame having a top surface in which a plurality of conductive holes are defined to correspondingly receive an upgrading CPU and having a bottom surface from which a plurality of pins extends downwardly;
a circuit board having a top surface to electrically connect to said plurality of pins and having a bottom surface on which multiple conductive bulbs are mounted to electrically connect to a motherboard of an XBOX™ game machine; and
a switch connected to the circuit board, wherein the operating frequency of the upgrading CPU is able to be adjusted by controlling the switch.

Other objects, advantages and novel features of the invention will become more apparent from the following detailed description when taken in conjunction with the accompanying drawings.

### BRIEF DESCRIPTION OF THE DRAWINGS

FIG. 1 is a schematic view showing the CPU upgrading adapter in accordance with the present invention is mounted on a motherboard of an XBOX game machine;

FIG. 2 is an exploded perspective view of the CPU upgrading adapter of FIG. 1;

FIG. 3 is a plan view of a bottom surface of the CPU upgrading adapter of FIG. 1;

FIG. 4 is a schematic view showing the CPU upgrading adapter in accordance with the present invention is mounted on a motherboard of an XBOX game machine, wherein an upgrading CPU is mounted on the upgrading adapter; and

FIG. 5 is a circuit diagram of the CPU upgrading adapter of the present invention;

FIGS. 6 to 10 show the correspondingly connections between the pins of an original Intel© Mobile Pentium-III™ 733 MHz CPU and the upgrading adapter of the present invention;

FIGS. 11 and 12 show the filtering capacitors for the main power pins (VCORE) and for the sub power pins (VTT) of the present invention.

### DETAILED DESCRIPTION OF PREFERRED EMBODIMENT

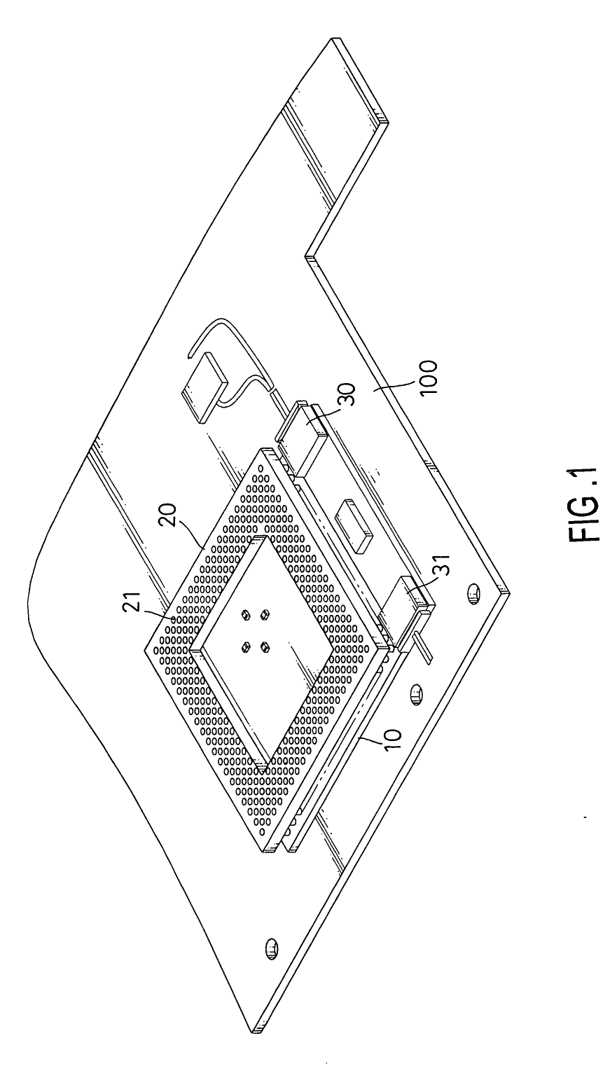

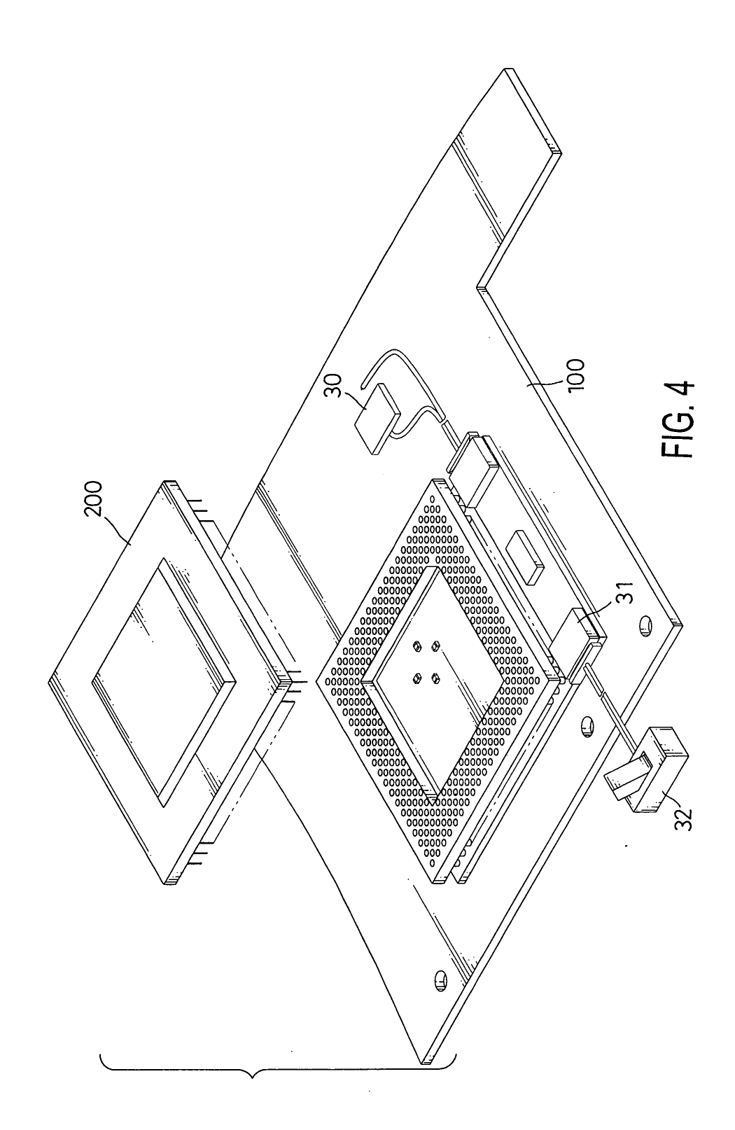

With reference to FIG. 1, a CPU upgrading adapter in accordance with the present invention is designed to be mounted on a motherboard (100) of an XBOX game machine to receive an upgrading CPU (200) as shown in FIG. 4. The original Intel© Mobile Pentium III™ 733 MHz CPU mounted on the motherboard (100) will be detached. The upgrading CPU (200) can be chosen from a normal CPU of a desktop computer such as an Intel© Pentium-III-S™ CPU, a Pentium-III™ CPU or a Celeron™ CPU. Once the original 733 MHz CPU is replaced with the upgrading CPU (200), the operating frequency can reach 1400 MHz. Moreover the original internal 128 KB cache memory of the 733 MHz CPU can be increased to 256 KB or 512 KB.

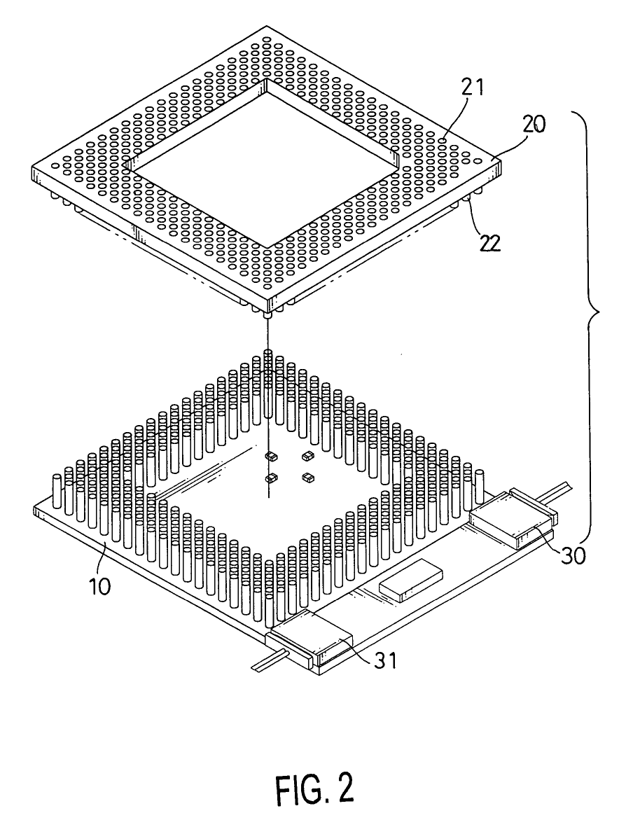

With reference to FIG. 2, the CPU upgrading adapter comprises a circuit board (10) and a socket frame (20) electrically connected to the circuit board (10). A power connector (30) and a turbo switch connector (31) are mounted on the circuit board (10). The socket frame (20) has a top surface on which multiple conductive holes (21) are defined to receive pins of pins of the upgrading CPU (200), as shown in FIG. 4. A bottom surface of the socket frame (20) has a plurality of conductive pins (22) that securely and electrically connect to the circuit board (10).

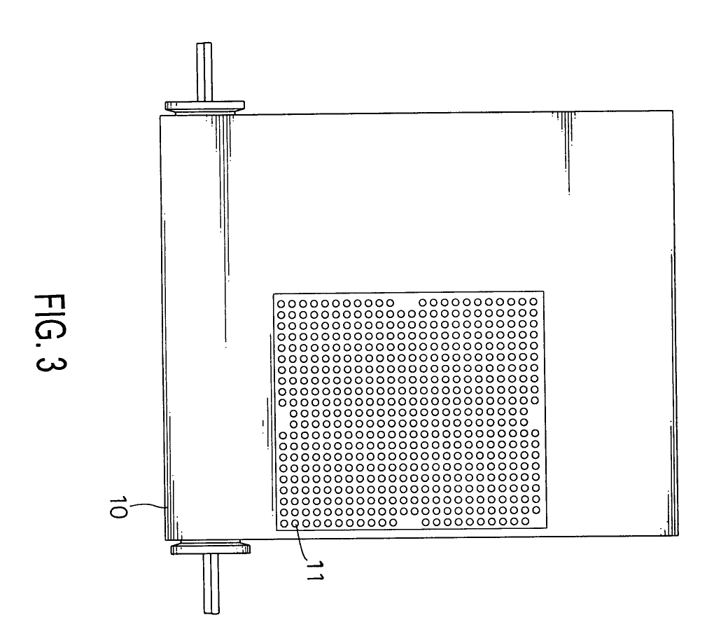

With reference to FIG. 3, a bottom surface of the board (10) has a plurality of conductive contacts (11) formed thereon for achieving an electrical connection to the motherboard (100). These conductive contacts (11) are made of solder bulbs or similar, wherein the quantity of the conductive contacts (11) is the same as the number of pins of the original CPU of the XBOX game machine so that the upgrading adapter can be correspondingly mounted on the motherboard (100).

In assembly, referring to FIG. 4, the upgrading CPU (200) is firstly engaged with the socket frame (20) of the CPU escalating adapter via the plurality of the CPU pins respectively being inserted into the conductive holes (21) of the socket frame (20). Moreover, a radiating fan (not shown) can be further mounted onto the upgrading CPU (200) in a conventional manner. Finally, the upgrading adapter together with the upgrading CPU (200) is mounted on the motherboard (100).

As mentioned above, the operating frequency of the original CPU is 733 MHz, but once the new upgrading CPU (200) has replaced the original one, the highest operating frequency may reach 1400 MHz. However, some software is unable to be executed by the upgrading CPU (200) with such a high operating frequency. Thus, the upgrading adapter in accordance with the present invention provides the function of operating frequency switching to meet different software requirements.

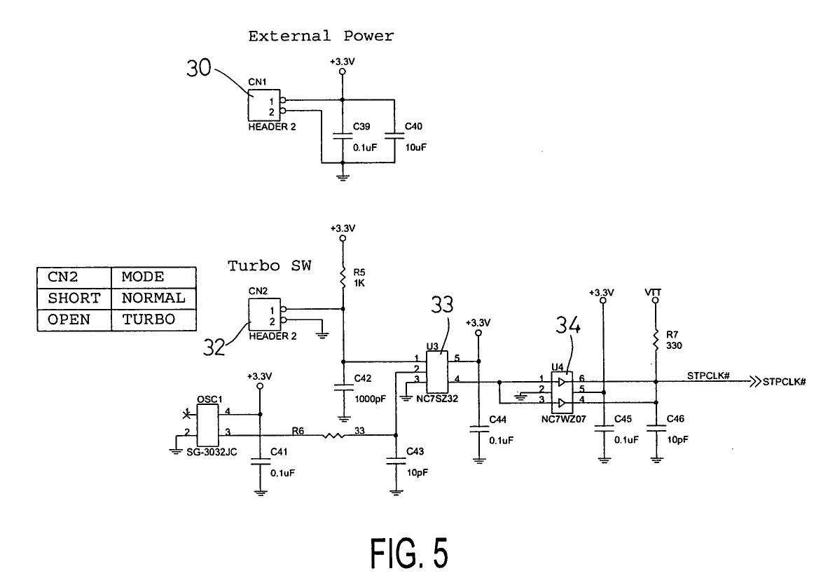

With reference to FIG. 5, a frequency switching circuit layout on the circuit board (10) is shown. The switching circuit utilizes two logic ICs (33, 34) to output a control signal (STPCLK) to determine the operating frequency of the upgrading CPU (200). The aforementioned power connector (30) is connected to the motherboard (100) to receive a 3.3-volts voltage that is further used as the operating voltage of the two logic ICs (33, 34). The turbo switch connector (31) further connects to a switch (32).

For a 1400 MHz upgrading CPU (200), as an example, when the switch (32) is switched to the “OPEN” status, the control signal (STPCLK) remains at a high level and the upgrading CPU (200) operates in the turbo mode, i.e. the operating frequency is maintained at 1400 MHz. On the other hand, after the switch (32) is changed to the “SHORT” status, the control signal (STPCLK) becomes a sequence of clock signals with approximately 32.768 KHz. While the upgrading CPU (200) receives the clock signals, the operating frequency of the CPU (200) will become a half of the original 1400 MHz, i.e. approximately 700 MHz. Since the 700 MHz operating frequency is quite close to the 733 MHz of the original Intel© Mobile Pentium-III™ CPU, software which requires a low operating frequency still can be executed with the new upgrading CPU (200).

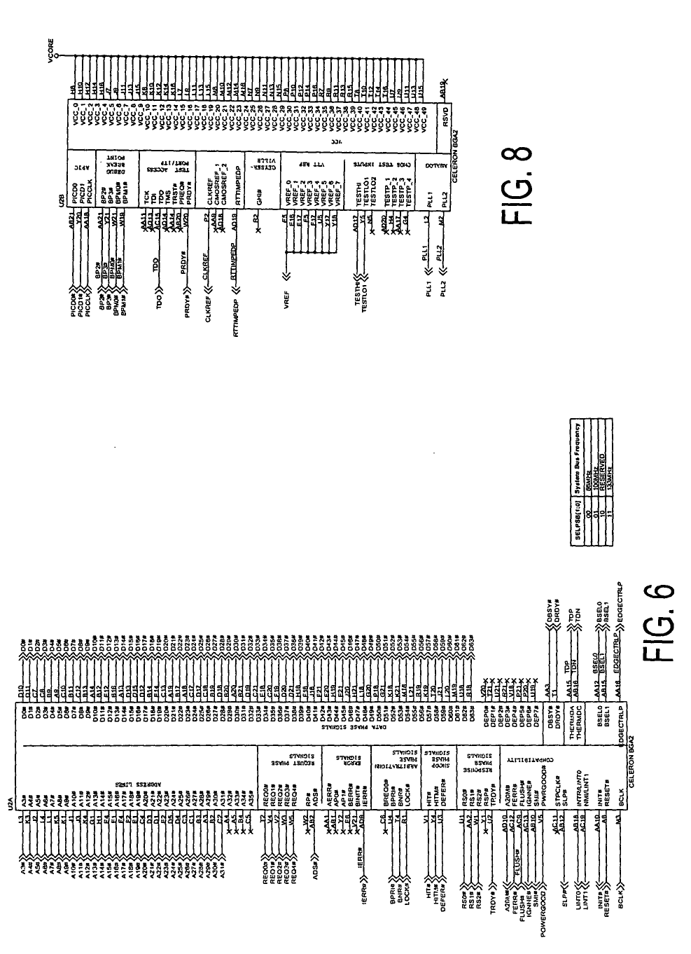

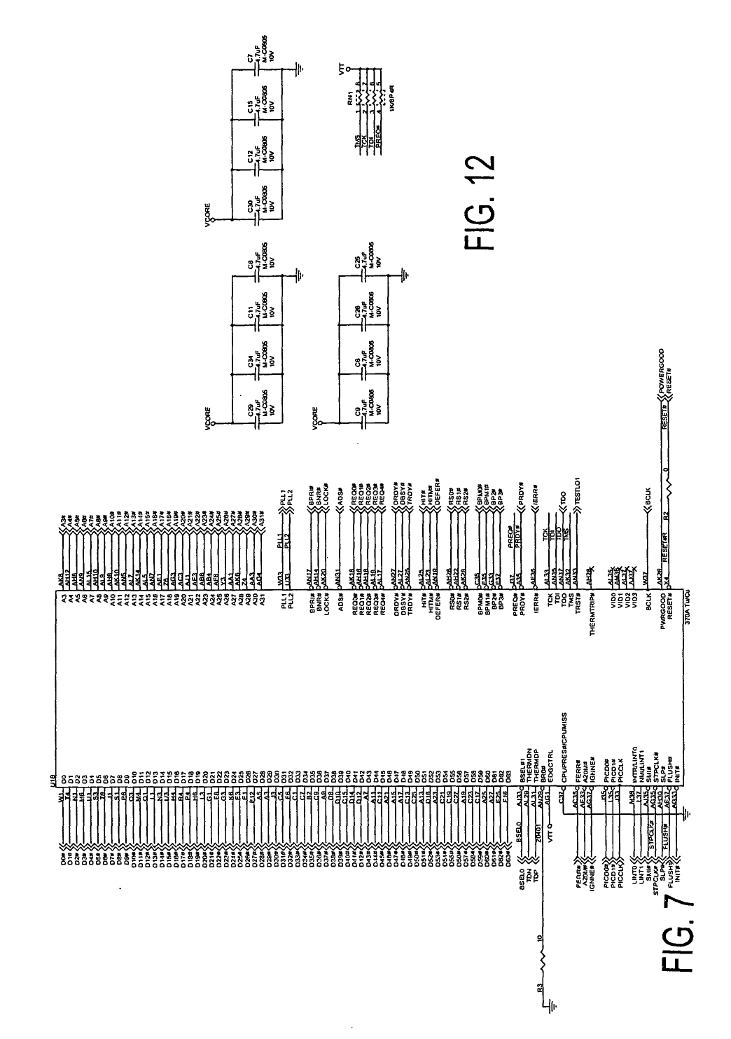

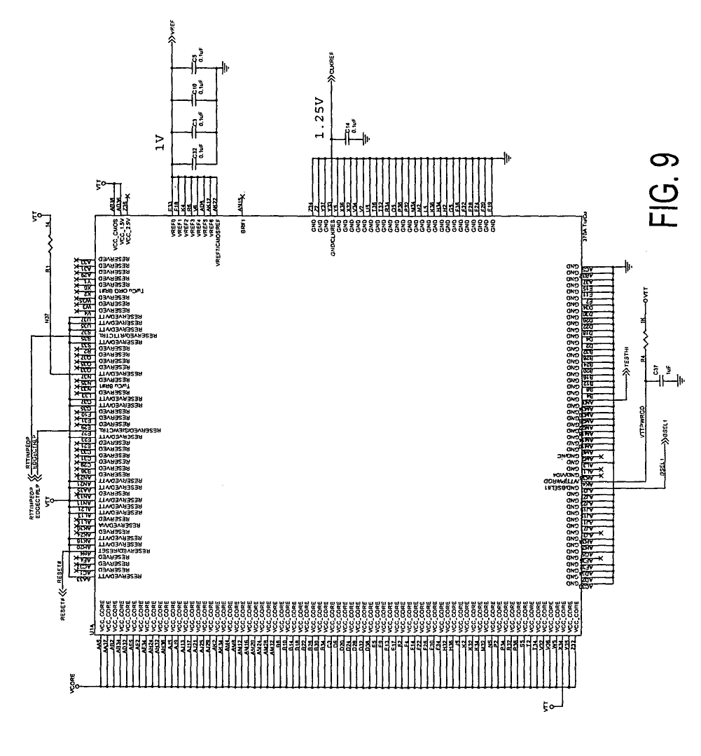

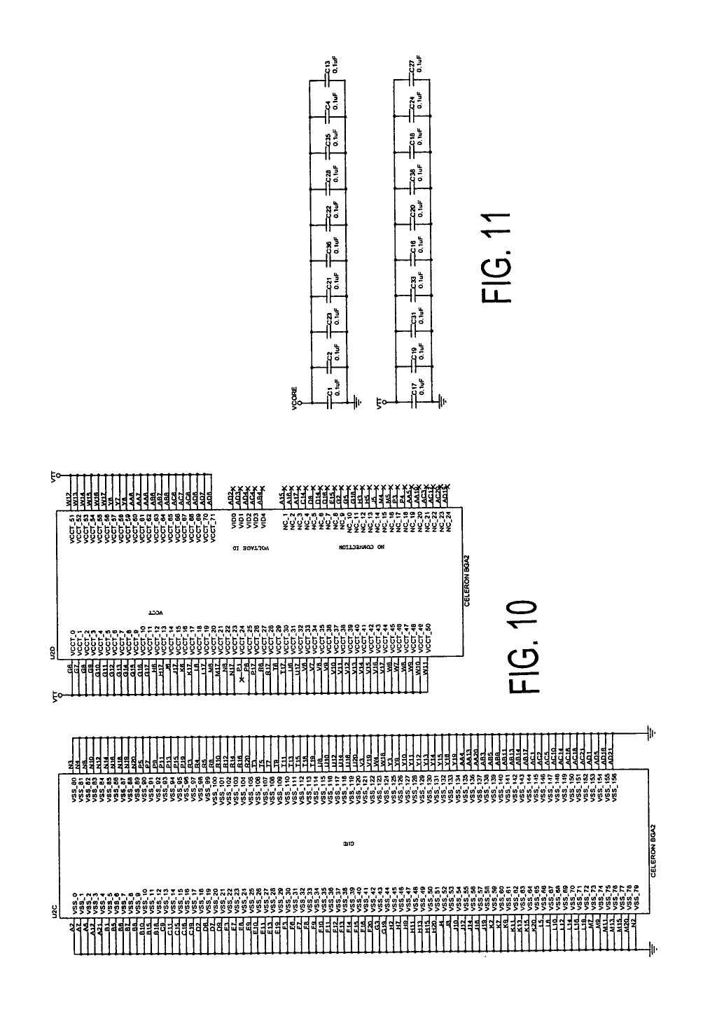

With reference to FIGS. 6 and 7, the signal pins of the original Intel© Mobile Pentium-III™ 733 MHz CPU as shown in FIG. 6 are correspondingly to the signal pins of the socket frame (20) of the present invention as shown in FIG. 7. The main power pins (VCORE) as shown in FIG. 8 of the original Intel© Mobile Pentium-III™ 733 MHz CPU are correspondingly connected to main power pins of the socket frame (20) of the present invention of FIG. 9, wherein the voltage level of the VCORE is able to be adjusted to 1.5 volts and then supply to the upgrading CPU (200). The secondary power pins (VTT), with a 1.5 volts voltage level, of the original Intel© Mobile Pentium-III™ 733 MHz CPU shown in FIG. 10 are also correspondingly connected to the socket frame (20) as shown in FIG. 9. With reference to FIGS. 11 and 12, the filtering capacitors for the main power pins (VCORE) and for the sub power pins (VTT) are respectively illustrated.

Based on the foregoing description, the upgrading adapter of the present invention allows the original Intel© Mobile Pentium-III™ 733 MHz CPU to be upgraded with a high speed CPU, such as an Intel© Pentium-III-S™ CPU, a Pentium-III™ CPU or a Celeron™ CPU, to improve the software processing speed and the performance of the XBOX machine.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A CPU upgrading adapter for an XBOX game machine, the CPU upgrading adapter comprising: a socket frame having a top surface in which a plurality of conductive holes are defined to adapted to receive an upgrading CPU and having a bottom surface from which a plurality of pins extends downwardly;
a circuit board having a top surface to electrically connect to said plurality of pins of the socket frame and having a bottom surface on which multiple conductive contacts are mounted to adapted to electrically connect to a motherboard of an XBOX game machine; and
a switch connected to the circuit board, wherein the operating frequency of the upgrading CPU is able to be adjusted by controlling the switch.

2. The CPU upgrading adapter as claimed in claim 1, wherein a power connector is mounted on the circuit board and electrically connects to the motherboard to receive an operating voltage.

3. The CPU upgrading adapter as claimed in claim 1, wherein the switch is connected to the circuit board through a turbo switch connector mounted on the circuit board.

4. The CPU upgrading adapter as claimed in claim 2, wherein the switch is connected to the circuit board through a turbo switch connector mounted on the circuit board.

5. The CPU upgrading adapter as claimed in claim 1, wherein the upgrading adapter is able to receive an upgrading CPU chosen from an Intel© Pentium-III-S™ CPU, a Pentium-III™ CPU or a Celeron™ CPU.

6. The CPU upgrading adapter as claimed in claim 4, wherein the upgrading adapter is able to receive an upgrading CPU chosen from an Intel© Pentium-III-S™ CPU, a Pentium-III™ CPU or a Celeron™ CPU.
